(19) United States
(12) Patent Application Publication
(10) Pub. No.: US 2026/0301360 A1
(43) Pub. Date: Oct. 1, 2026

(54) INFORMATION PROCESSING METHOD, INFORMATION PROCESSING APPARATUS, AND PROGRAM

(71) Applicant: Sony Group Corporation, Tokyo (JP)

(72) Inventors: Hirotaka TANAKA, Kanagawa (JP); Yusei KUJIRAI, Tokyo (JP); Ryo TAKAHASHI, Tokyo (JP)

(73) Assignee: Sony Group Corporation, Tokyo (JP)

(21) Appl. No.: 19/477,047

(22) PCT Filed: Mar. 19, 2024
(86) PCT No.: PCT/JP2024/010632

§ 371 Date: Oct. 20, 2025

(30) Foreign Application Priority Data
Apr. 27, 2023 (JP) 2023-073318

(51) Int. Cl. G06V 10/30; G06V 20/56

(52) U.S. Cl. CPC G06V 10/30; G06V 20/56

(57) ABSTRACT

An information processing method of the present disclosure includes generation processing of a filter map and filter processing. In the generation processing of the filter map, a position of a sensing space in which aliasing is assumed is defined in the filter map. In the filter processing, filter performance of a noise filter that performs filtering of sensing data is set for each position of the sensing space, based on the filter map.

### TECHNICAL FIELD

The present invention relates to an information processing method, an information processing apparatus, and a program.

### BACKGROUND ART

In order to implement autonomous traveling, estimation of a self-position and recognition of a surrounding environment need to be performed. As sensors for recognizing the surrounding environment, distance measuring sensors of a laser imaging detection and ranging (LiDAR) method are known.

### CITATION LIST

### Patent Literature

PTL 1: WO 2018/020656

### SUMMARY

### Technical Problem

With the distance measuring sensor of the LiDAR method, a distant object may be erroneously recognized as a nearby object due to aliasing. In order to prevent erroneous detection, a method of cutting out a signal having low signal strength by using a noise filter, cutting out salt-and-pepper noise by spatially or temporally performing smoothing, or the like is conceivable, but uniform processing may cause even necessary information to be lost.

In view of this, the present disclosure proposes an information processing method, an information processing apparatus, and a program that can reduce erroneous detection due to aliasing.

### Solution to Problem

According to the present disclosure, an information processing method executed by a computer is provided. The information processing method includes defining a position of a sensing space in which aliasing is assumed in a filter map, and setting filter performance of a noise filter that performs filtering of sensing data for each position of the sensing space, based on the filter map. According to the present disclosure, an information processing apparatus and a program that cause a computer to implement the information processing method are provided.

### BRIEF DESCRIPTION OF DRAWINGS

FIG. 1 is a diagram depicting an example of acquiring a color image and a depth image of a space near a window.

FIG. 2 is a diagram depicting an effect of reducing aliasing by a noise filter.

FIG. 3 is a diagram depicting an effect of reducing aliasing by the noise filter.

FIG. 4 is a diagram depicting examples of objects in which aliasing is likely to occur.

FIG. 5 is a diagram depicting a method of setting filter performance for an area in which aliasing is assumed (hereinafter referred to as an aliasing assumed area)

FIG. 6 is a diagram depicting an example of a configuration of a robot.

FIG. 7 is a diagram depicting an example of the configuration of the robot.

FIG. 8 is a diagram depicting an example of a configuration of an information processing apparatus that controls the robot.

FIG. 9 is a diagram depicting an example of filter information.

FIG. 10 is a diagram depicting an example of a filter map.

FIG. 11 is a diagram depicting an example of a processing flow.

FIG. 12 is a diagram depicting an example of a hardware configuration of the information processing apparatus.

### DESCRIPTION OF EMBODIMENTS

Embodiments of the present disclosure will be described below in detail with reference to the drawings. In each of the following embodiments, the same parts are denoted by the same reference signs, and thus overlapping description will be omitted.

Note that the description will be given in the following order.
1. Overview
   1-1. Aliasing in LiDAR Measurement
   1-2. Setting of Filter Performance for Aliasing Assumed Area
2. Configuration of Robot
3. Configuration of Information Processing Apparatus
4. Filter Information
5. Filter Map
6. Processing Flow
7. Hardware Configuration Example
8. Effects

### 1. Overview

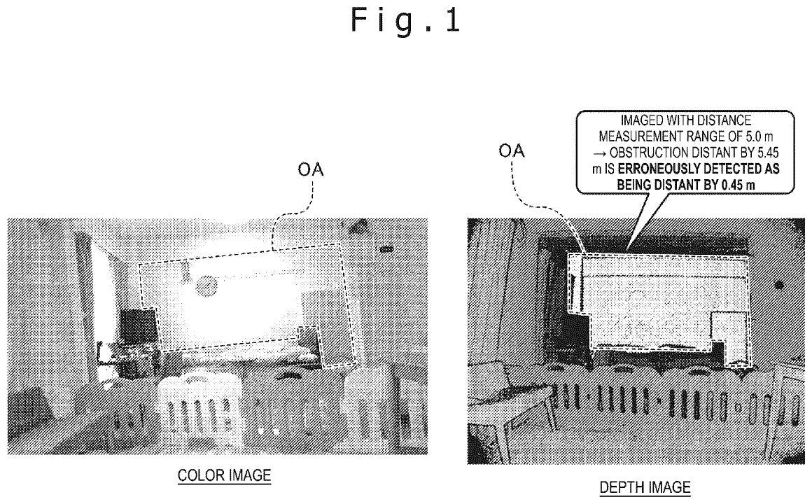

An overview of the present disclosure will be described below with reference to FIGS. 1 to 5. The following will describe an example in which autonomous traveling is performed indoors (for example, in a facility such as a factory); however, the present disclosure is also applicable to a case in which autonomous traveling is performed in an outdoor space.

### 1-1. Aliasing in LiDAR Measurement

FIG. 1 is a diagram depicting an example of acquiring a color image and a depth image of a space near a window. The color image means an image obtained by detecting visible light with an image sensor and imaging the visible light. The depth image means an image obtained by performing gradation displaying of a depth detected based on sensing data and imaging the depth.

When an automatic guided vehicle (AGV) is caused to travel in a facility, the AGV may erroneously recognize a distant object as a nearby obstruction and then make a stop.

In the example of FIG. 1, light entering from a window is reflected by a wall and illuminates the inside of a room. A clock is mounted on the wall, and the light is strongly reflected on a surface of the clock. A region surrounded by the dotted line is an object region OA indicating objects such as the wall and the clock having high reflectance. In the depth image, aliasing occurs in a light signal from the wall and the clock being parts reflecting light. The actual wall and clock are present at positions distant by 5.45 m; however, due to aliasing, they are detected as obstructions distant by 0.45 m in imaging with a distance measurement range of 5.0 m.

Such erroneous detection can be resolved to some extent through a method of cutting out a signal having low signal strength by using a noise filter, cutting out salt-and-pepper noise, or the like; however, the erroneous detection may not be sufficiently removed depending on the reflectance, the size, and the angle of reflection of the object. Forcibly increasing the filter performance may cause even necessary information to be lost.

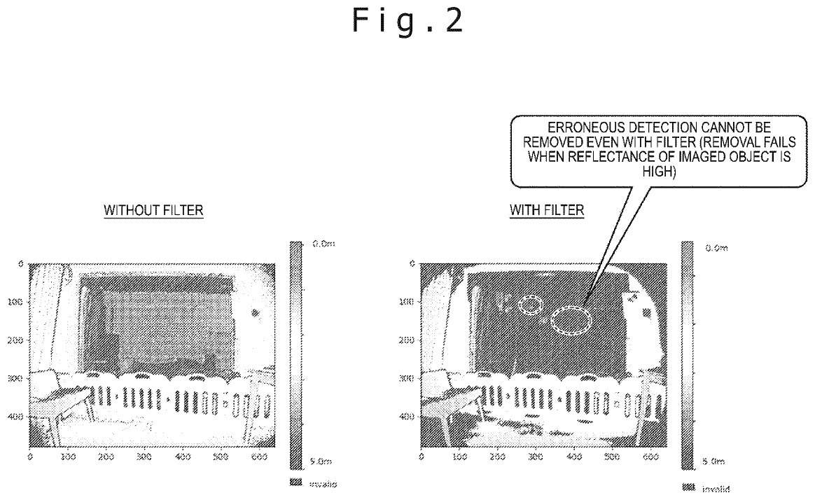

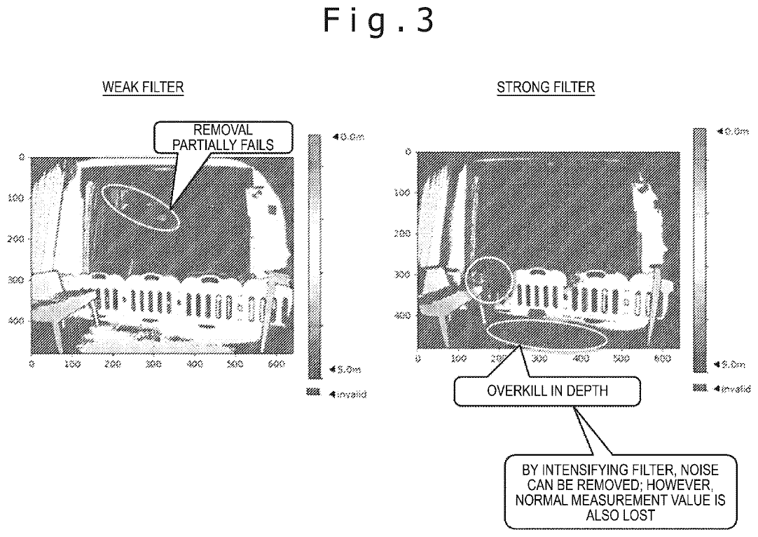

FIGS. 2 and 3 are each a diagram depicting an effect of reducing aliasing by a noise filter.

The left figure of FIG. 2 is a depth image when a noise filter is not applied. The right figure of FIG. 2 is a depth image when a noise filter is applied. Applying the noise filter improves the erroneous detection on the wall and clock parts, but does not sufficiently eliminate noise of parts having high reflectance.

The left figure of FIG. 3 depicts a result of filtering when filter performance is low. The right figure of FIG. 3 depicts a result of filtering when filter performance is high. When the filter performance is low, the noise of the parts having high reflectance is not sufficiently removed. Increasing the filter performance removes the noise of the parts having high reflectance, but may lose even normal data due to overkill.

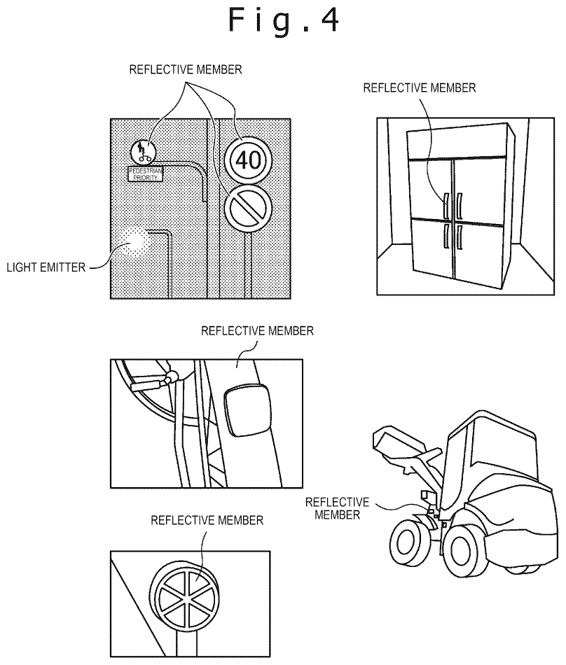

The problem of aliasing may occur in various objects. FIG. 4 is a diagram depicting examples of objects in which aliasing is likely to occur. Examples of the objects in which aliasing is likely to occur include a high-luminance light emitter, a high-reflectance reflective member, and the like. When such a member is present, a normal noise filter cannot sufficiently remove noise, and a malfunction may occur.

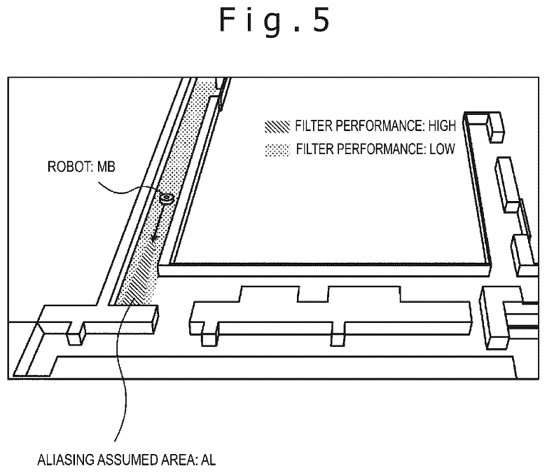

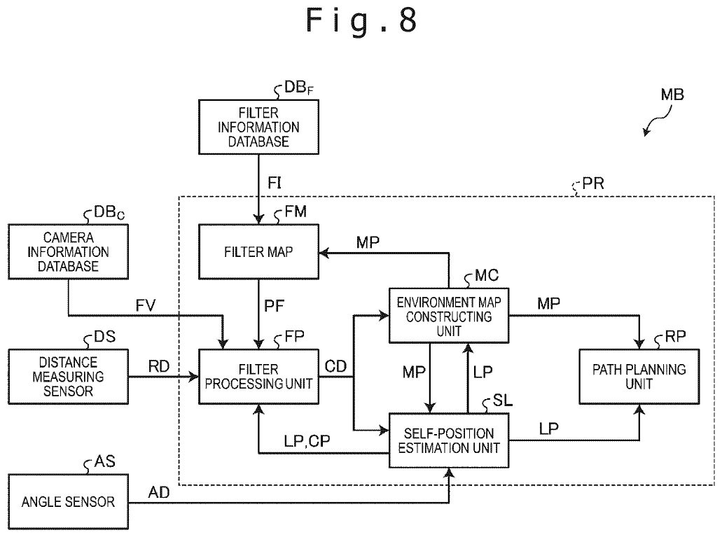

As described above, when the filter performance is increased, an adverse effect due to overkill occurs. Meanwhile, the inventor of the present invention has found that erroneous detection repeatedly occurs in a specific location or object. Thus, in the present disclosure, a location or an object in which aliasing is likely to occur is identified in a preliminary examination. Such an identified location or object is registered in a filter map MP (see FIG. 8) as an aliasing assumed area AL (see FIG. 5). By selectively increasing filter strength in the aliasing assumed area AL, erroneous detection can be reduced while avoiding overkill.

### 1-2. Setting of Filter Performance for Aliasing Assumed Area

FIG. 5 is a diagram depicting a method of setting the filter performance for the aliasing assumed area AL.

A robot MB travels in an indoor passage. An object prone to induce aliasing (aliasing inducing object) is present ahead of the passage. Examples of the aliasing inducing object include a white wall that induces aliasing through strong reflection of light and the like. A region in which the aliasing inducing object is present is registered as the aliasing assumed area AL. High filter performance is applied to a signal from the aliasing assumed area AL. A normal noise filter is applied to a signal from an object other than the aliasing inducing object.

The filter performance can be defined according to a type (algorithm) and strength (filter constant) of the noise filter. A space to be sensed (sensing space) is assigned different filter performance for each position, according to likelihood that aliasing occurs. The filter map FM defines three-dimensional distribution of the filter performance. Based on the filter map FM, the filter performance of the noise filter is set for each position of the sensing space. The setting of the filter performance means, for example, setting of at least one of the algorithm and the filter constant of the noise filter.

For example, in the example of FIG. 1, the filter performance is not uniformly set for the entire data in a field of view of a sensor, but the filter performance is selectively increased for data in the object region OA (for example, the wall and the clock having high reflectance) corresponding to the aliasing assumed area AL. This prevents accurate information included in a region other than the object region OA from being lost.

The following will describe a specific configuration of the robot MB.

### 2. Configuration of Robot

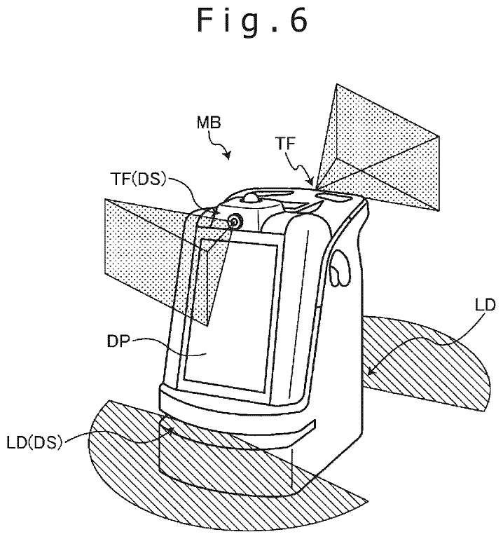

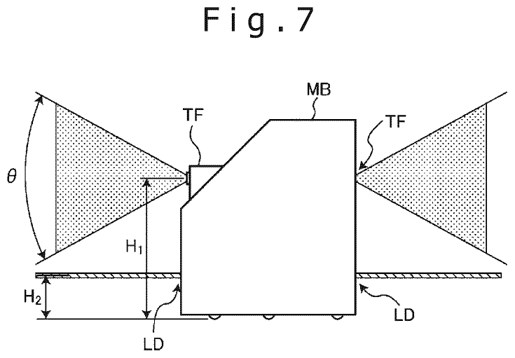

FIGS. 6 and 7 are each a diagram depicting an example of a configuration of the robot MB.

The robot MB is an autonomous mobile moving body that moves while recognizing a surrounding environment by using a technology such as simultaneous localization and mapping (SLAM). The robot MB includes a time of flight (ToF) camera TF and a 2D-LiDAR sensor LD as distance measuring sensors DS. One ToF camera TF and one 2D-LiDAR sensor LD are installed in each of the front part and the rear part of the robot MB. The robot MB includes a touch panel DP as a human-machine interface.

The ToF camera TF acquires three-dimensional information by measuring time of flight for each two-dimensionally arranged pixel. The 2D-LiDAR sensor LD acquires two-dimensional information by scanning laser light in the horizontal direction. An installation height H₁ of the ToF camera TF from the ground is, for example, 600 mm. An installation height H₂ of the 2D-LiDAR sensor LD is, for example, 200 mm. A measurement range 0 of the ToF camera TF in an elevation angle direction is, for example, 50°.

FIGS. 6 and 7 each depict a type of the robot MB that travels on wheels. Examples of this type of the robot MB include a delivery robot, a catering robot, a patrol robot, a forklift, a wheel loader, and the like.

However, the robot MB of the present disclosure is not limited thereto. The technology of the present disclosure is also applicable to a type of the robot MB, such as a drone, that flies with a propeller.

### 3. Configuration of Information Processing Apparatus

FIG. 8 is a diagram depicting an example of a configuration of an information processing apparatus PR that controls the robot MB.

The robot MB includes a distance measuring sensors DS, an angle sensor AS, a camera information database DB_{C}, a filter information database DB_{F}, and an information processing apparatus PR. The camera information database DB_{C} stores information related to viewing angles of the ToF camera TF and the 2D-LiDAR sensor LD as viewing angle information FV. The filter information database DB_{F} stores information related to the type and the strength of the noise filter as filter information FI.

The distance measuring sensor DS measures a distance to an object. The distance measuring sensor DS generates a point cloud and a depth image, based on distance information. The point cloud means a point cloud obtained by projecting the depth image on three-dimensional coordinates. The distance measuring sensor DS outputs the generated point cloud and depth image as sensing data RD. The angle sensor AS detects an inclination angle of a reference coordinate system of the robot MB. The angle sensor AS outputs the detected inclination angle as angle information AD.

The information processing apparatus PR performs estimation of a self-position LP of the robot MB and planning of a moving path of the robot MB, based on various pieces of data and information acquired from the distance measuring sensors DS, the angle sensor AS, the camera information database DB_{C}, and the filter information database DB_{F}. The information processing apparatus PR includes a filter map FM, a filter processing unit FP, a self-position estimation unit SL, an environment map constructing unit MC, and a path planning unit RP, for example.

The filter map FM defines a position of a sensing space in which aliasing is assumed. The sensing space means an operation space of the robot MB to be sensed by the distance measuring sensors DS. The filter map FM includes information related to distribution of the filter performance (performance distribution information PF) in the sensing space. For example, the filter performance is defined by the type and the strength of the noise filter. The filter map FM defines the type and the strength of the noise filter for each position of the sensing space, based on the filter information FI.

The filter processing unit RP performs filtering of the sensing data RD by using the noise filter. The filter processing unit FP sets the filter performance of the noise filter for each position of the sensing space, based on the performance distribution information PF included in the filter map FM. The filter processing unit RP outputs correction data CD obtained by filtering the sensing data RD using the noise filter.

For example, the filter processing unit RP acquires information related to the self-position LP and a camera posture CP of the robot MB from the self-position estimation unit SL. The camera posture CP means positions and postures of the ToF camera TF and the 2D-LiDAR sensor LD. The self-position estimation unit SL estimates the camera posture CP, based on the angle information AD. The filter processing unit RP acquires information related to a viewing angle FV of the ToF camera TF from the camera information database DB_{C}. The viewing angle FV includes horizontal and vertical viewing angles.

The filter processing unit RP estimates sensing positions of the distance measuring sensors DS (the ToF sensor TF and the 2D-LiDAR sensor LD), based on the self-position LP and the camera posture CP. The filter processing unit FP filters the sensing data RD by using the noise filter having the filter performance associated with the sensing positions.

The environment map constructing unit MC constructs an environment map MP of the sensing space, based on the correction data CD and the self-position LP. The environment map MP is constructed as, for example, an occupancy grid map. The generated environment map MP is stored in a map database (not depicted). The self-position estimation unit SI performs estimation of the self-position LP by using the correction data CD and the environment map MP. The self-position LP includes information related to a position and a posture of the robot MB. Generation of the environment map MP and estimation of the self-position LP are performed using SLAM.

The environment map MP is a high-accuracy map in which inaccuracy due to aliasing is reduced. The filter map FM is generated by associating the position and the filter performance (the type and the strength of the noise filter) on the environment map MP. The path planning unit RP plans a moving path of the robot MB, based on the environment map MP and the self-position LP. The path planning unit RP can perform track search in order to reach a designated destination along the moving path while avoiding an obstruction. For path planning and track search methods, known methods can be used.

### 4. Filter Information

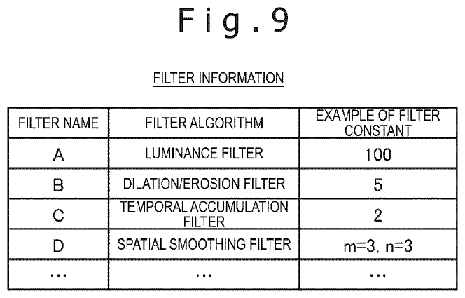

FIG. 9 is a diagram depicting an example of the filter information FI.

The filter information FI includes information related to a filter algorithm (type of the noise filter) and its strength (filter constant) for removing noise included in the sensing data RD. Commonly used noise filters include a luminance filter, a dilation/erosion filter, a temporal accumulation filter, a spatial smoothing filter, and the like. A system developer can set the filter algorithm and the filter constant for each aliasing assumed area AL.

The luminance filter cuts out a luminance signal whose luminance value is below a threshold. Strength of the luminance filter is represented by the luminance value as the threshold (0 to 65535 in a case of 16 bits). The dilation/erosion filter performs color replacement of the neighborhood of a target pixel (white or black) so as to have the same color as the target pixel. Strength of the dilation/erosion filter is represented by a range of neighboring pixels (number of pixels) on which the color replacement is performed. The temporal accumulation filter accumulates data over time and smoothes the data. Strength of the temporal accumulation filter is represented by the number of times of data accumulation. The spatial smoothing filter uses an average pixel value of the target pixel and its neighboring pixels as a processed pixel value of the target pixel. Strength of the spatial smoothing filter is represented by a range of neighboring pixels. The range of neighboring pixels is represented as a range having m rows and n columns centered on the target pixel.

The noise filters described above are examples. As the noise filters, noise filters other than those described above are also applicable. As other noise filters, for example, a filter described in JP 2021-50988 can be used.

### 5. Filter Map

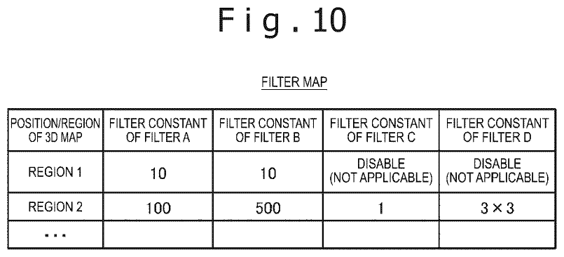

FIG. 10 is a diagram depicting an example of the filter map FM.

The filter map FM indicates distribution of the filter performance in the environment map MP. “Region 1” and “region 2” of FIG. 10 each indicate the aliasing assumed area AL. In the example of FIG. 10, the filter performance of the noise filter is defined for each aliasing assumed area AL.

The aliasing assumed area AL is set as a location in which aliasing is likely to occur. A system developer can designate a location, such as a traffic sign (high-reflectance object), to which a strong noise filter is to be applied as the aliasing assumed area AL in advance.

The system developer makes the filter performance of the noise filter applied to each aliasing assumed area AL different, according to likelihood that aliasing occurs.

For example, in “region 1”, “filter A” (luminance filter) and “filter B” (dilation/erosion filter) are applied. The filter constant of “filter A” is 10, and the filter constant of “filter B” is 10.

In “region 2”, “filter A”, “filter B”, “filter” (temporal accumulation filter), and “filter D” (spatial smoothing filter) are applied. The filter constant of “filter A” is 100, the filter constant of “filter B” is 500, the filter constant of “filter C” is 1, and the filter constant of “filter D” is 3×3.

Any method may be used to designate the aliasing assumed area AL. For example, the system developer can designate the aliasing assumed area AL by designating three-dimensional coordinates defining the outer edge of the aliasing assumed area AL or designating two-dimensional coordinates defining the outer edge of the aliasing assumed area AL on a 2D map (a floor map or the like).

The system developer can also designate the aliasing assumed area AL, based on features of the object in which aliasing is likely to occur. For example, the system developer registers the features of the object in which aliasing is likely to occur (for example, features of a reflective part of a circular speed sign) with the filter map FM in association with the filter performance. The filter processing unit FP selectively increases the filter performance on the sensing data RD from the object having the registered features.

For example, the filter processing unit FP detects the object region OA in which occurrence of aliasing is assumed from an image capturing the sensing space, based on the features of the object registered with the filter map FM. The image may be a color image captured by a visible light camera, or may be a luminance image detected by the ToF camera TF. The color image is obtained by detecting visible light with an image sensor and imaging the visible light, and the luminance image is obtained by detecting infrared light with an image sensor and imaging the infrared light.

The filter processing unit RP compares the image and the sensing data RD, and extracts a data region corresponding to the detected object region OA from the sensing data RD. The filter processing unit RP applies the noise filter having the filter performance allowing for elimination of aliasing to the extracted data region.

### 6. Processing Flow

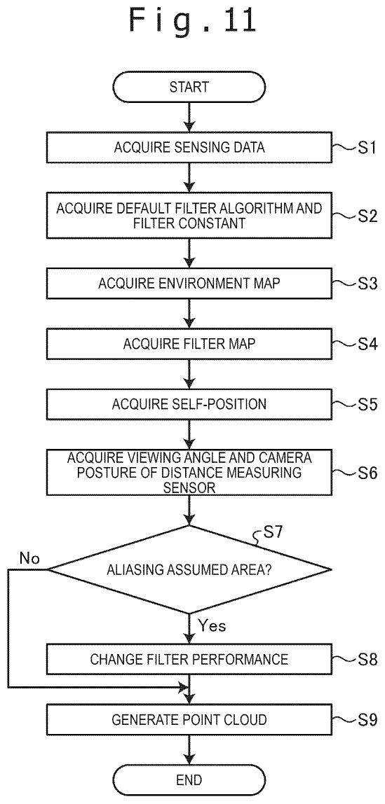

FIG. 11 is a diagram depicting an example of a processing flow.

The information processing apparatus PR acquires the sensing data RD from the distance measuring sensor DS (Step S1). The information processing apparatus PR acquires a default filter algorithm and filter constant from the filter information database DBF (Step S2).

The information processing apparatus PR acquires the environment map MP from the map database (Step S3). The information processing apparatus PR defines distribution of the filter performance in the environment map MP, based on position information of the aliasing assumed area AL. The information processing apparatus PR acquires map information in which the environment map MP and the filter performance are associated as the filter map FM (Step S4).

The information processing apparatus PR acquires the self-position LP, based on the sensing data RD (Step S5). The information processing apparatus PR acquires the viewing angle FV of the distance measuring sensor DS from the camera information database DB_{C}. The information processing apparatus PR acquires the camera posture CP, based on the angle information AD detected by the angle sensor AS (Step S6).

The information processing apparatus PR estimates the current sensing position of the distance measuring sensor DS, based on the self-position LP, the camera posture CP, and the viewing angle FV. The information processing apparatus PR determines whether or not the sensing position is in the aliasing assumed area AL (Step S7).

When the sensing position is in the aliasing assumed area AL (Yes in Step S7), the information processing apparatus PR switches the filter performance of the noise filter to the filter performance associated with the aliasing assumed area AL, based on the filter map FM (Step S8). The information processing apparatus PR filters the sensing data RD based on the switched filter performance, and generates a point cloud (Step S9).

When the sensing position is not in the aliasing assumed area AL (No in Step S7), the information processing apparatus PR filters the sensing data RD based on the current filter performance, and generates a point cloud (Step S9).

Note that order of the processes (Step S2, Step S3, and Step S6) of reading information from the database is not limited to that in FIG. 11.

### 7. Hardware Configuration Example

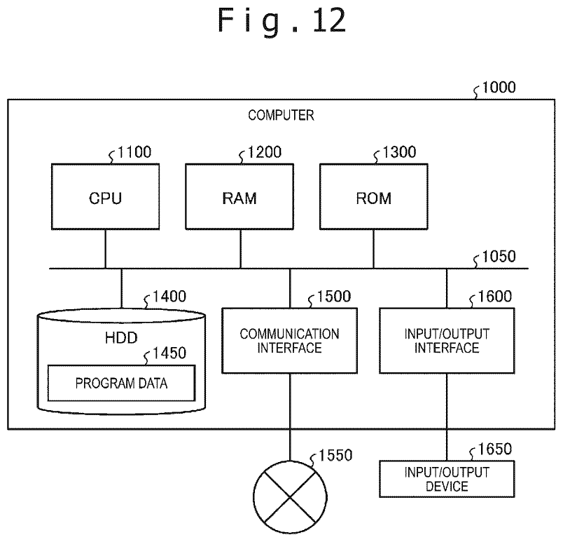

FIG. 12 is a diagram depicting an example of a hardware configuration of the information processing apparatus PR.

Information processing of the information processing apparatus PR is implemented by a computer 1000, for example. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on programs (program data 1450) stored in the ROM 1300 or the HDD 1400, and controls each unit. For example, the CPU 1100 loads the programs stored in the ROM 1300 or the HDD 1400 into the RAM 1200, and executes processing corresponding to various programs.

The ROM 1300 stores a boot program, such as a basic input output system (BIOS) which is executed by the CPU 1100 when the computer 1000 is booted, a program dependent upon hardware of the computer 1000, and the like.

The HDD 1400 is a non-transitory computer-readable recording medium that non-transitorily records the program to be executed by the CPU 1100, data to be used by such a program, and the like. Specifically, the HDD 1400 is a recording medium that records an information processing program according to the embodiment as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device, such as a keyboard and a mouse, via the input/output interface 1600. The CPU 1100 transmits data to an output device, such as a display apparatus, a speaker, and a printer, via the input/output interface 1600. The input/output interface 1600 may function as a media interface that reads a program and the like recorded in a predetermined recording medium (media). The media is, for example, an optical recording medium such as a Digital Versatile Disc (DVD) and a Phase change rewritable Disk (PD), a magneto-optical recording medium such as a Magneto-Optical disk (MO), a tape medium, a magnetic recording medium, a semiconductor memory, or the like.

For example, when the computer 1000 functions as the information processing apparatus PR according to the embodiment, the CPU 1100 of the computer 1000 executes the information processing program loaded in the RAM 1200, and thereby implements the functions of each unit described above. The HDD 1400 stores the information processing program according to the present disclosure, various models, and various pieces of data. Note that the CPU 1100 reads the program data 1450 from the HDD 1400 and executes the program data 1450, but may acquire these programs from another apparatus via the external network 1550 as another example.

### 8. Effects

An information processing method of the present disclosure includes generation processing of the filter map FM and filter processing. In the generation processing of the filter map FM, the position of the sensing space in which aliasing is assumed is defined in the filter map FM. In the filter processing, the filter performance of the noise filter that performs filtering of the sensing data RD is set for each position of the sensing space, based on the filter map FM. An information processing apparatus and a program of the present disclosure cause the computer 1000 to implement the information processing method of the present disclosure.

According to this configuration, an area in which aliasing is likely to occur is registered with the filter map FM in advance. The filter performance can be set according to likelihood that aliasing occurs, and therefore erroneous detection due to aliasing can be appropriately reduced.

The filter map FM defines the type and the strength of the noise filter for each position of the sensing space.

According to this configuration, the filter performance can be finely set according to a state of the assumed noise.

The information processing method of the present disclosure includes construction processing of the environment map MP. In the construction processing of the environment map MP, the environment map MP of the sensing space is constructed based on the correction data CD obtained by filtering the sensing data RD using the noise filter.

According to this configuration, an accurate environment map MP is constructed.

The information processing method of the present disclosure includes self-position estimation processing.

In the self-position estimation processing, estimation of the self-position LP is performed by using the correction data CD and the environment map MP.

According to this configuration, the self-position LP is accurately estimated.

In the filter processing, the sensing position is estimated based on the self-position LP. In the filter processing, the sensing data RD is filtered by using the noise filter having the filter performance associated with the sensing position.

According to this configuration, the sensing position is accurately identified based on information of the high-accuracy self-position LP. Therefore, the filter performance to be applied to the sensing position is appropriately extracted.

In the filter processing, the object region OA in which aliasing is assumed to occur is detected from an image capturing the sensing space. In the filter processing, the noise filter having the filter performance that allows aliasing to be eliminated is applied to a data region of the sensing data RD corresponding to the object region OA.

According to this configuration, data of the object region OA being a cause for aliasing is appropriately filtered based on image information.

Note that the effects described in this specification are merely illustrative and not restrictive, and other effects may be present.

### SUPPLEMENTARY NOTES

Note that the present technology can also employ the following configurations.
(1)

An information processing method executed by a computer, the information processing method including:
defining a position of a sensing space in which aliasing is assumed in a filter map; and
setting filter performance of a noise filter that performs filtering of sensing data for each position of the sensing space, based on the filter map.
(2)

The information processing method according to (1) above, wherein
the filter map defines a type and a strength of the noise filter for each position of the sensing space.
(3)

The information processing method according to (1) or (2) above, further including
constructing an environment map of the sensing space, based on correction data obtained by filtering the sensing data using the noise filter.
(4)

The information processing method according to (3) above, further including
performing estimation of a self-position by using the correction data and the environment map.
(5)

The information processing method according to (4) above, further including:
estimating a sensing position, based on the self-position; and
filtering the sensing data by using the noise filter having the filter performance associated with the sensing position.
(6)

The information processing method according to any one of (1) to (5) above, further including:
detecting an object region in which the aliasing is assumed to occur from an image capturing the sensing space; and
applying the noise filter having the filter performance that allows the aliasing to be eliminated to a data region of the sensing data corresponding to the object region.
(7)

An information processing apparatus including:
a filter map defining a position of a sensing space in which aliasing is assumed; and
a filter processing unit configured to set filter performance of a noise filter that performs filtering of sensing data for each position of the sensing space, based on the filter map.
(8)

A program causing a computer to implement:
defining a position of a sensing space in which aliasing is assumed in a filter map; and
setting filter performance of a noise filter that performs filtering of sensing data for each position of the sensing space, based on the filter map.

### REFERENCE SIGNS LIST

CD Correction data
FM Filter map
FP Filter processing unit
LP Self-position
MP Environment map
OA Object region
PR Information processing apparatus
RD Sensing data

1. An information processing method executed by a computer, the information processing method comprising:
defining a position of a sensing space in which aliasing is assumed in a filter map; and
setting filter performance of a noise filter that performs filtering of sensing data for each position of the sensing space, based on the filter map.

2. The information processing method according to claim 1, wherein
the filter map defines a type and a strength of the noise filter for each position of the sensing space.

3. The information processing method according to claim 1, further comprising
constructing an environment map of the sensing space, based on correction data obtained by filtering the sensing data using the noise filter.

4. The information processing method according to claim 3, further comprising
performing estimation of a self-position by using the correction data and the environment map.

5. The information processing method according to claim 4, further comprising:
estimating a sensing position, based on the self-position; and
filtering the sensing data by using the noise filter having the filter performance associated with the sensing position.

6. The information processing method according to claim 1, further comprising:
detecting an object region in which the aliasing is assumed to occur from an image capturing the sensing space; and
applying the noise filter having the filter performance that allows the aliasing to be eliminated to a data region of the sensing data corresponding to the object region.

7. An information processing apparatus comprising:
a filter map defining a position of a sensing space in which aliasing is assumed; and
a filter processing unit configured to set filter performance of a noise filter that performs filtering of sensing data for each position of the sensing space, based on the filter map.

8. A program causing a computer to implement:
defining a position of a sensing space in which aliasing is assumed in a filter map; and
setting filter performance of a noise filter that performs filtering of sensing data for each position of the sensing space, based on the filter map.
